(19) United States
(12) Patent Application Publication
(10) Pub. No.: US 2002/0116454 A1
(43) Pub. Date: Aug. 22, 2002

(54) System and method for providing communication among legacy systems using web objects for legacy functions

(76) Inventors: William Dyla, Chicago, IL (US); Michael David Gallagher, Chicago, IL (US); Stuart Douglas Hannay, Chicago, IL (US); Robert Leonard Hays, Chicago, IL (US); David John Lindstrom, Chicago, IL (US)

Correspondence Address: Michael D. Bednarek, SHAW PITTMAN LLP, 1650 Tysons Boulevard, McLean, VA, 22102, US

(21) Appl. No.: 09/968,663

(22) Filed: Oct. 2, 2001

Related U.S. Application Data
(60) Provisional application No. 60/256,971, filed on Dec. 21, 2000.

(51) Int. Cl. G06F 15/16

(52) U.S. Cl. 709/203; 709/230

(57) ABSTRACT

A system for and method of facilitating data communication between (i) a first computer system that runs a legacy application and is operable as a service provider and (ii) a second computer system that is operable as a requester. Multi-layered software adapters are respectively interposed between an electronic network and each of the first and second computers thereby connecting the first and second computers to each other via the adapters. The first computer, which is operable as a service provider and runs the legacy application, publishes an interface model of its legacy application functions. The second computer, which is operable as a requester, looks up, via its adapter, the published interface model when a request for data that is available from the legacy application is made by the second computer. The adapters then communicate with each other in a common format and protocol to exchange information and data as is desired. In a preferred implementation, published interface models are searchable by requestor adapters. Also, at least some of the layers in the multi-layer adapter are plugable or selectable.

This application claims the benefit of U.S. Provisional patent application Ser. No. 60/256,971, SYSTEM AND METHOD FOR PROVIDING COMMUNICATION AMONG LEGACY SYSTEMS USING WEB OBJECTS FOR LEGACY FUNCTIONS, filed Dec. 21, 2000, which is incorporated herein by reference.

### BACKGROUND

1. Field of the Invention

The present invention is directed to systems and methods for connecting legacy computer systems through a common communication mechanism.

2. Background of the Invention

Companies that wish to take advantage of computer browser technology, the Internet and electronic commerce often face difficulties when attempting to harness the information available from advanced legacy systems. Organizations depend on legacy enterprise information systems to codify business practices and collect, process and analyze business data. In many ways, these legacy systems are the brains of an enterprise—a complex, poorly understood mass upon which the organization relies for its very existence.

In large information intensive organizations such as banks, legacy information systems are typically large, heterogeneous, distributed, evolving, dynamic, long-lived, mission critical, systems. Much of the code in these systems is likely to be redundant, often providing the same or similar capabilities in different subsystems that make up the overall enterprise information systems. Moreover, enterprise information systems are heterogeneous for much the same reason. As features are added to an enterprise information system, new technologies and components are selected and integrated.

Internet technologies make it possible to create new, more effective sales and delivery channels, and to enable new types of financial management services that are highly flexible, personalized, interactive, and integrated. To fully exploit new e-business channels and their associated business practices, financial institutions must integrate the new processes with existing channels and legacy information technology (IT) systems. Indeed, the ability to bridge the divide between legacy system business logic and the Web, for example, is the critical business issue facing financial institutions as they adopt new e-business processes.

In the context of banking, for example, customers have come to expect not only reliability and security, but also a continuously evolving set of services (such as viewing account information on line or enabling Internet-based payments). Customers also expect that these services will be provided at little or no additional cost.

The competition to reduce cost and meet increasing customer expectations is fierce. As a consequence, a key factor in achieving customer satisfaction today is technology, most often in the form of e-commerce tools for both business-to-business and business-to-consumer transactions.

In the past, creating a new service meant an expensive and time-intensive effort, essentially teaching older systems to interact with one another or with the Internet. A wide variety of software systems have been installed over the years to meet these specific needs. Unfortunately, however, many of these solutions are incompatible, difficult to use and to maintain.

Since the 1960's and 1970's, financial institutions, large businesses and governmental organizations have had the ability to automate their internal processing of financial data and transactions, using centralized computer systems. However, there continues to be difficulties in fully harnessing the information available from these systems.

More specifically, within a bank or any other enterprise, it is often desirable to access the legacy systems and processes and/or communicate among several legacy systems and processes. That is, there is often a need for a consistent, reusable, searchable system for accessing legacy data. Unfortunately, most legacy systems are closed systems that were purchased from different outside vendors or were developed in a vacuum. Current solutions for communication among these legacy systems are usually ad hoc designed systems requiring hundreds or even thousands of man-hours to implement. In many instances, ad hoc solutions are inefficient and expensive.

There is also an external problem in that, even if legacy systems can communicate among each other, they may still have difficulty communicating at the business layer or providing services that have synergy with each other.

Thus, there remains a need to address the problem of system incompatability in a methodical way that does not rely on ad hoc solutions.

### SUMMARY OF THE INVENTION

It is therefore an object of the present invention to provide a method and system for facilitating communication among legacy systems.

It is another object of the present invention to provide a method and system for simplifying access to data and information that is stored and/or generated on legacy systems.

It is still another object of the present invention to provide for standardization for access to legacy systems.

It is still another object of the present invention to provide interfaces to applications within a business domain.

It is yet another object of the present invention to provide a multi-layered software architecture for facilitating access across existing electronic networks to data and information that is stored or generated on legacy systems.

It is a further object of the present invention to provide a multi-layered software architecture for facilitating access to data and information that is stored or generated on legacy systems, wherein at least some of the layers can be easily replaced or upgraded.

It is still another object of the present invention to provide a system and method for searching for published interfaces to legacy systems.

It is yet another object of the present invention to provide a system and method for extracting data or information from a legacy system in which a directory service is employed to publish identification information about software adapters, which provide access to the legacy system.

It is yet another object of the present invention to provide for strong authentication between requesting applications and legacy systems (and vice versa) using Public Key technology (well-known to the industry), employing electronic certificates.

It is yet another object of the present invention to provide for security of sensitive data through use of encryption and electronic certificates. This secure communications path includes requesting application to legacy systems as well as to management and directory services.

These and other objects of the present invention will become apparent upon a reading of the following summary and detailed description in conjunction with the accompanying drawings.

To address the problem of system incompatibility, the present invention connects incompatible systems through a common communication format and protocol. To provide a new service that draws information from one or more applications, the system provides software that allows older systems with conflicting data transmission standards and formats to understand the language of newer systems and other legacy systems. The present invention provides these functions in a systemized, rather than ad hoc, manner.

As a practical matter, the present invention addresses two basic problems encountered by large organizations such as a bank, namely, consistent and efficient access to legacy systems and the ability to maintain flexibility and adaptability for future modification.

In a preferred implementation of the invention, a software adapter, preferably in conjunction with other functional software layers are combined to create a unified architecture that can be systematically plugged into legacy systems (or act as interfaces thereto) and that is operable to access the full depth of information from the legacy systems.

By providing a system and method for understanding and transmitting to more than one system (largely a matter of coping with differences in data transmission format and/or protocols), software developers can quickly combine data from many different applications to meet both internal and external customer needs. Thus, the present invention provides a software-based “adapter” to, for example, address communication problems and reduce development time for new e-commerce and on line banking services. The adapter of the present invention is a customizable software tool that is capable of, for example, translating an organization's various proprietary banking services into a standard format for transmission over internal and external networks.

The present invention is also referred to herein, as a whole, as “WOLF,” which stands for Web Objects for Legacy Functions. In accordance with the present invention, a WOLF-enabled legacy or even non-legacy system can communicate with any other system that is WOLF-enabled.

A significant aspect of the present invention is the “adapter” (also referred to herein as a “WOLF adapter”), which is a customizable software tool that provides the appearance of translating various proprietary systems data and processes into a standard format and protocol. Any WOLF-enabled system can communicate with any other system that has a WOLF adapter (i.e., is WOLF enabled). As a result, web sites or other client applications can make information requests to any legacy application through WOLF adapters without the need to consider protocol or data formats. Alternatively, a legacy system that uses the functionality offered by WOLF-enabled applications can communicate with other legacy systems configured in like manner. As a result, web sites and client applications, as well as legacy systems can access and process information from new and old applications without considering protocol or data formats.

The present invention is not a temporary initiative for enabling on line banking or faster application development. Rather, it is flexible and adaptable. Since the adapter software is ?based upon open technologies (such as JAVA and XML, it is easily modified with a built in set of customization tools and ready-to-handle future communication formats and protocols.

The present invention also includes features to accommodate unique environments where the WOLF adapters may be installed. Adapter management tools allows local administrators runtime management functions (such as start, stop and pause of the adapter without the need of restarting systems), as well as access basic diagnostic and reporting information. Tools for “proactive management” may also be plugged-in which allow dynamic, runtime management functionality based on pre-configured statistical watermarks. For example, additional adapter instances may be automatically started based on pre-configured volume of system network traffic or queue sizes. The adapter software can be managed with a number of different tools to allow maximum flexibility when monitoring and/or managing communication between systems or providing local and remote site support.

More specifically, WOLF adapters allow multiple interfaces to applications within, for example, a business domain. In accordance with the present invention, “clients” communicate with “service-providing” legacy systems to make requests through WOLF adapters without concern for remote communication, protocol or data format. The WOLF adapter preferably comprises several software layers, some of which are easily replaceable or can be considered to be “pluggable,” thereby permitting relatively simple layer upgrade when desired. Each WOLF adapter preferably also includes a set of convenience tools that allow customization of the adapter.

By default, WOLF adapters provide a Java Application Programming Interface (API) which makes use of a Remote Procedure Call (RPC) paradigm which uses XML as a communications technology. This is accomplished through the use of stubs and skeletons (terms well-known to the industry), which may be implemented through dynamically generated proxies on the client side.

WOLF adapters provide for the marshalling and unmarshalling of data for remote communication. By default, marshalling and unmarshalling accomplishes the mapping of data from Java classes to XML (for communication) and back again.

In one embodiment the default syntax for XML used in communication between WOLF adapters is the Simple Object Access Protocol (SOAP), an industry standard.

In a preferred embodiment of the present invention, service providers publish adapters, which expose legacy systems, to a directory naming service via which requestors can search for and identify adapters that can provide the type of data or information that the requestor is seeking. By implementing a common naming service that is accessible to both requesters and service providers it is possible, in accordance with the present invention, to quickly and efficiently connect one legacy system to another or to connect a web-based or other client application to a legacy system.

The present invention contains a configurable table facility which can be used at runtime to provide such things as management and logging. Tables of keys, values and messages may be configured for access (add, read, update, delete of table rows) at runtime. Events may be generated in response to changes in the table. Tables are currently used for internal management of the invention, which also interacts with the message logging facility to provide persistence of table entries. This facility may also be configured and used and extended by client applications to provide for runtime application management and message logging.

The present invention also supports and facilitates standard processes used in the Information Technology community to facilitate and control development and change to a system. This involves, among other things, the use of imbedded tools for design, code generation, change control, security and management using tools and standards well-known to the industry.

### BRIEF DESCRIPTION OF THE DRAWINGS

FIG. 1 is a schematic diagram of an exemplary software architecture in accordance with the present invention.

FIG. 2 is a schematic diagram depicting an exemplary connection process between two WOLF-enabled systems in accordance with the present invention.

FIG. 3 is logical diagram of an exemplary system in accordance with the present invention.

### TERMINOLOGY

The following are definitions of terms that are used throughout the description of the present invention. A “Legacy” system is considered to be any system currently in operation. A “Service” exposes functionality of a legacy system through a published, callable function. An “Interface” is a collection of related services. A “domain” is a logical organizational area which, for the purposes of this invention, exposes functionality of its legacy systems through one or more interfaces, having one or more services.

### DETAILED DESCRIPTION OF THE INVENTION

The WOLF (Web Objects for Legacy Functions) adapter (or simply “adapter”) is a customizable software tool that provides the appearance of translating various proprietary systems data and processes into a standard format and protocol. WOLF-enabled systems can communicate with any other system that has a WOLF adapter. By virtue of the present invention, web sites and other client applications can make information requests to any legacy application through WOLF adapters without the user having to consider protocol or data formats.

While the following description is directed to and makes several references to the “banking” industry and environment, those skilled in the art will appreciate that the present invention is more widely applicable. Thus, while the present invention provides certain advantages for a banking organization, the principles underlying WOLF offer benefits to other industries as well.

The following description of WOLF is intended to provide information necessary to build new WOLF adapters between internal or external clients (Data Requesters) and legacy applications (Service Providers) within a business domain.

A WOLF adapter is preferably operable on any computer/network platform that supports, for example, Java 1.2.2 or later running on a platform such as Windows NT 4.0 (and later) and Solaris 2.8 (and later). Those skilled in the art will appreciate that the listing of particular types of computer equipment, operating systems or commercial software tools are for exemplary purposes only and are not intended to narrow the scope of the present invention in any way. In this vein, the present invention relies on a number of well-known software concepts and tools. Specifically, the WOLF adapter is preferably developed employing well-known:

object-oriented design tools;

object-oriented design concepts;

Java production code;

directory services; and

UML (Universal Modeling Language) and XMI (Extensible Modeling Interchange) modeling tools.

The following describes the architecture and interfaces of the WOLF adapter within the context of a Java Naming and Directory Interface (JNDI). Key concepts describing how adapters operate and how they interface with existing systems are described.

Java Naming Directory Interface (JNDI)

Directory services play an important role in WOLF adapters by providing access to a variety of information about the various components that exist in the enterprise's (e.g., a bank's) network environment. The WOLF adapter preferably incorporates a naming facility for providing human-understandable namespaces that organize and identify these components.

The Java Naming and Directory Interface (JNDI) is an Application Programming Interface (API, a well-known industry term) specified in the Java programming language that provides directory and naming functionality to Java applications. The API is defined as independent of any specific directory service implementation to allow a variety of directories to be accessed in a common way.

The JNDI/WOLF architecture can also be considered an API. Java applications use the JNDI API to access a variety of naming and directory services, including legacy systems exposed through WOLF. As a result, it is also possible to harness the strength of the JNDI API to effect searches for Service Provider adapters that have been published to the naming and directory services. Accordingly, a requester need not know at the outset what the name of the Service Provider adapter is before generating a Requester-side adapter. More specifically, the present invention preferably utilizes the service provider interface (SPI) of JNDI to effect the aforementioned searching capability.

JNDI plays two roles in WOLF adapter development and implementation. First, JNDI acts as a database of configuration information for Service Providers (legacy systems made available via WOLF adapters), Requesters (applications, e.g. clients, that want to gain access to Service Provider legacy systems) and their related interfaces and resources. Second, JNDI acts as a location-transparent naming service. This allows WOLF adapters to access services by name, without regard to specific address or other information about where the service is actually hosted.

Typically, in a large enterprise, a computing environment includes several naming facilities representing different parts of a large, composite namespace. For example, the Internet Domain Name System (DNS) is used as the top-level naming facility for many organizations. Internally, these organizations may use a directory service such as LDAP (lightweight directory access protocol) or NDS (Novelle directory service), or naming facilities such as NIS (network information service). DSML (Directory Service Markup Language) might be used at development time for local representations of a directory using a flat file. However, from a user's perspective, there is only one namespace consisting of composite names. The most commonly used example of this is the format of Internet URL addresses: Each web site address is a composite name that spans multiple naming facilities.

Applications that utilize directory services (including WOLF adapters) must also support composite names. By utilizing JNDI, the WOLF adapter is independent of a particular implementation of a directory or naming service. For instance, applications may use JNDI to access information stored on servers running an implementation of LDAP or an implementation of DSML). This allows developers to access network entities connected to WOLF adapters regardless of the implementation or naming facility being used.

With JNDI, a WOLF adapter can attach its own objects to the namespace. JNDI also enables adapters to discover and retrieve objects of any type, (performed via the query facilities of directories) enabling end users to see logical entities that allow easier discovery and identification of the objects in the network.

One example of how the WOLF adapter of the present invention implements JNDI is shown below. In this example, an application that wants to access an account balance system (of a bank) needs the corresponding service provider:

BankingSystem = adapter.lookup(“retail banking system”);
account = BankingSystem.getAccount(“AccountNumber”);
balance = account.getBalance();

The adapter does all of the work needed to locate information for and construct access to the banking system.

Directory Service for WOLF Adapters

One of the primary functions of the WOLF adapter is to map names to objects of any type within the network and facilitate their access by name. The WOLF adapter accomplishes this through the use of directory objects. A directory object is used to represent the information in a computing environment. A directory object has attributes, which include both an identifier and a set of values.

Directory objects provide operations for creating, adding, removing, and modifying attributes associated with the directory object. When a directory object is also a naming context, trees of directory information can be represented where interior nodes not only behave like naming contexts, but also contain attributes.

A directory service provides secured access to all information about adapters (e.g., interfaces, Service Providers and transports within domains) in a network environment. A directory service uses a naming system for purpose of identifying and organizing directory objects to represent this information. Information is organized in a hierarchical manner to provide mapping between human understandable names and directory objects. These directory objects provide an association between attributes and values. Both directory objects and hierarchies of directory objects may be secured through use of user credentials and encrypted communication links.

A fundamental facility in the WOLF adapter is the naming service—the means by which names are associated with objects, and by which objects are found, given their names. The computing environment of a large enterprise, such as a bank, typically consists of several domains. Within these domains are specific services that are designed to implement one or more business functions.

The domain might be named, for example, after an organizational unit such as retail, mortgage, or treasury. It contains the domain's adapters, depots, and users definitions. WOLF adapters facilitate reduced coupling between domains, whereby each domain can control how services are exposed. Control is established with access control to the Directory, machine names, ports for adapters and transports for interfaces. Each domain may have several depots, adapters, and managers.

One example of a domain in a bank is Retail Savings. Within this domain are several service providers that may expose interfaces to a legacy system. These interfaces provide business functions (such as retrieving account information) to requesters inside and outside of the domain.

The WOLF Adapter System

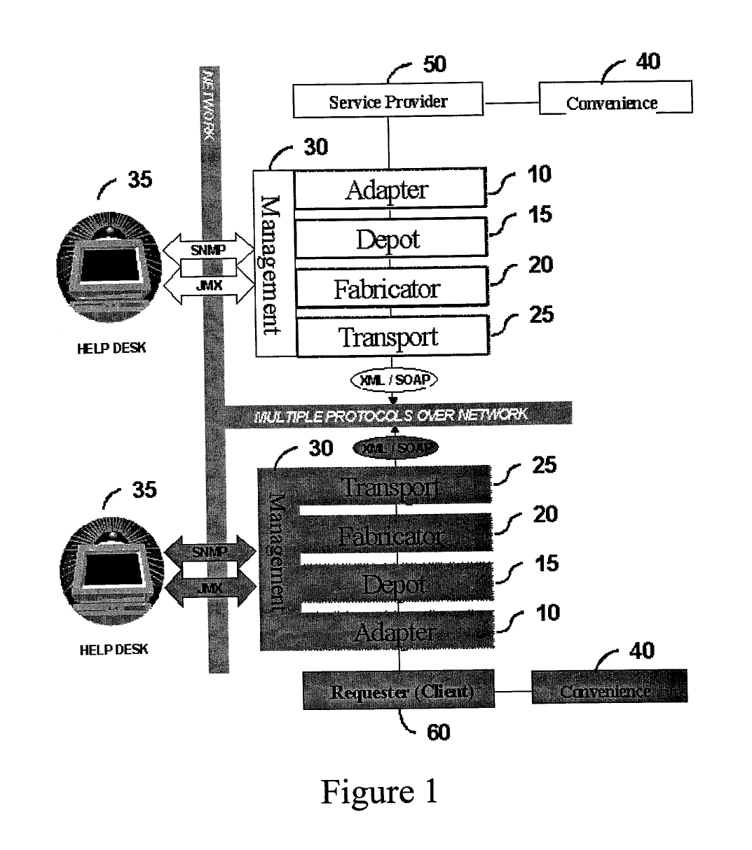

As mentioned already, WOLF adapters publish interfaces to applications within a business domain. Clients communicating with service-providing legacy systems can make requests through WOLF adapters without concern for remote communication, protocol or data format. The WOLF adapter preferably comprises five software layers plus a set of convenience tools that allow customization of the adapter. FIG. 1 shows a preferred basic architecture of a WOLF adapter. As shown in the figure, the current WOLF adapter architecture is designed with four core layers and one extensibility layer for convenience functions. Note that the use of architecture layers allows existing functionality (such as security) to be formalized into additional architectural layers (not shown in FIG. 1) in the future, without affecting current layers.

Before describing the function of each layer in the architecture, it is important to more clearly define the two main parties that benefit or implement WOLF adapters, namely, Service Providers and Requesters. The term “Service Provider” refers to any existing application that needs to have services or information exposed to other applications. These applications may be within the same domain, in another business domain, or access the Service Provider from outside the organization or enterprise.

“Requesters,” on the other hand, are clients that seek data or services from one or more Service Providers. Requesters may collect information from a single Service Provider within one domain. Requesters can also interact with data from several legacy systems by calling several Service Providers. Service Providers might also aggregate data by themselves calling one or more other Service Providers to provide more complete, robust services. This data is frequently returned to a web browser, although the Requester can be any client application.

Referring now to FIG. 1, the Adapter layer 10 is the primary interface point for the WOLF adapter, connecting Clients (Requesters) with legacy systems (Service Providers). This software layer also implements the Java Naming and Directory Interface (JNDI) for the Service Provider interface and provides name parsing for the adapter. This software layer also implements name parsing for the adapter. WOLF Adapter users develop to the JNDI interface using bind( ), lookup( ) and listBindings( ) functions well-known to those skilled in the art. The Adapter layer also provides name parsing for composite names, compound names and federated names in an organization's namespace.

The Depot layer 15 provides a storage location for domain and interface information. This layer utilizes Unified Modeling Language (UML)/XML Metadata Interchange (XMI) for definitions of data and services, and is responsible for access to both stubs and skeletons and Domain contracts. The Depot accesses directory services, which serve as a repository of guidelines for mapping from the business world to the technology world, defining what data is transported. When a lookup is executed on the adapter the depot returns the attributes and description of the retail banking systems interface. The depot retrieves the retail banking system interface description from a directory service which has stored the description using the XMI language.

The Fabricator layer 20 converts Service Provider and Requester data formats for transmission over the network. This layer of the adapter maps the semantics of the application level business request to the syntax of the wire level format for passing over the transport technology of choice. The Fabricator is preferably designed so that alternative syntax encoders and decoders can be implemented without affecting the way in which applications interact with the adapter. Besides giving the ability to use different encoding between Requesters and Service Providers, plug-in Fabricators enable support for language bindings other than Java.

SOAP (Simple Object Access Protocol, a form of XML) is becoming a recognized current standard for Business-to-Business (B2B) communication. One embodiment of the Fabricator layer makes use of the SOAP standard for its internal adapter to adapter communication. For example, the default Fabricator layer encoding converts data to and from SOAP, for transmission between WOLF Adapters and a network. This marshalling and unmarshalling of messages is a key part of what makes the WOLF adapter software highly flexible for use in a variety of applications.

The use of SOAP as an encoding also has the advantage of allowing organizations to deploy applications which talk SOAP and communicate to legacy applications through WOLF Service Providers. A full implementation of this is the deployment of Web services, supporting standards such as WSDL (Web Services Description Language) and UDDI (Universal Discovery and Description Interface) which, in turn, communicate to legacy systems through WOLF adapters).

The Transport layer 25 manages the flow of messages over the network using established transport protocols (e.g. HTTP, MQ, HTTPS, etc.). The transport layer also manages runtime resources needed by these transports and communicates responses back to the originating Requester.

The specific protocol (transport) to be used is determined by the transport layer, based on quality of service (QOS) desired by the Requester and supported by the interface of target services.

The URI (Universal Resource Identifier), a well-known industry term, of the specific service being requested is contained within individual messages. The Fabricator layer (which resolves URI's and marshals/unmarshals messages) registers “listeners” with the transport layer. A dispatcher in the transport layer forwards requests to these listeners.

For example, the default implementation of the Transport layer 25 manages the flow of SOAP messages over the network using established transport protocols (e.g. MQ, HTTP, HTTPS, etc.).

WOLF Adapters communicate with each other using the Transport Layer, using agreed upon protocols. The messages may contain any kind of content constructed by the Fabricator. Transports (such as HTTP, HTTPS, RMI, MQ, etc.) provide a lower level protocol for both sides of communication across the wire to interpret streams of character data.

The Transport Layer 25 preferably implements at least four important functions:

(a) “Open” brings-up instances of Servers (HTTP, RMI, etc.) within Service Provider adapters that listen for requests. These instances are bound to JNDI, so that they may be accessed through JNDI names.

(b) “Lookup” is used by Requester adapters to find the running Server instances (through JNDI names) to call with Client requests.

(c) “DoRequestService” is called by another layer (currently Fabricator) within a Requester adapter to pass a Request to a Service Provider Adapter and get a Response.

(d) “ReceiveData” is called by a Server instance to pass a Request to another layer (currently Fabricator) within a Service Provider Adapter. It also passes-back the Response to the Requester Adapter.

Transport manager classes on Service Provider adapters encapsulate Server management for different protocols, such as Opening and Closing a Server. These classes also handle the JNDI Bind of Server instances. Examples are: httpsTransportManager, rmiTransportManager, httpTransportManager.

Transport manager classes on Requester adapters encapsulate remote communication with Servers for different protocols. They also handle the JNDI Lookup of Server instances. Examples are: httpTransport, httpsTransport, rmiTransport.

The Management layer 30 provides control of basic WOLF adapter functions (such as Start, Stop and Pause). The currently implemented Management functions can be accessed via management consoles 35 running Java Management Extensions (JMX), management consoles 35 running SNMP (Simple Network Management Protocol), and by command line access via Remote Method Invocation (RMI). The Management layer 30 also provides runtime monitoring of the ‘health’ of WOLF adapters. “Proactive” events can be generated (such as sending alert messages to systems management tools) to quickly take corrective action.

As should be apparent, the WOLF adapter layer 10 facilitates the publishing and access of services using the Java Naming and Directory Interface (JNDI). The WOLF adapter layer 10 uses a JNDI context to look up adapters. JNDI provides a standard way to find adapters in the same way as other naming services like LDAP or DNS. The layer also provides an interface for access to all management information.

An Adapter Controller in the Management layer 30 constructs and holds a reference to all of the layers and provides the actual control mechanism to regulate all of the layers in the overall WOLF Adapter.

The Convenience layer 40 allows programmers to extend the WOLF adapter's functionality and add new features without disturbing the adapter's basic code. This layer's functions and tools facilitate the ease of use of WOLF adapters. Thus, this layer of the WOLF Adapter contains and facilitates the inclusion of customized functions. Convenience functionality can also preferably be developed independently by domain developers.

A significant feature of the present invention is that of the software layers described above, the Fabricator, Transport and Management layers are preferably each selectable, or “pluggable”, in the sense that each of these layers is a separate entity that can be replaced without having to recompile the adapter with which the replaced layer is integrated. These layers are preferably libraries that are loaded at run time, rather than program code that needs to be compiled with program code of, for example, the Adapter layer. Thus, the present invention is particularly adaptable for the potential of future growth and encoding and protocol choices.

There are a number of advantages to an architecture of “pluggable” layers. Adapter Owners see advantages such as: (1) Adapter Owners can choose an infrastructure that allows choices in Quality of Service (QOS). (2) They allow a smaller software footprint. Administrators see advantages such as: (1) They allow the selection of infrastructure technologies to move from a task of application coding to a task of configuration. (2) They allow for an organization structure where choices of technologies are a task of administration rather than a task of development. (3) They give adapter owners freedom to choose an organizational structure to support adapters. (4) They allow organizations to centralize infrastructure decisions. Developers see advantages such as: (1) They completely abstract, or hide, the underlying infrastructure. (2) They remove developers from activities associated with implementing infrastructure. (3) They allow developers to build custom plug-ins for specific needs of client applications.

Security

WOLF adapters enable and employ various aspects related to Security. Authentication (the verification of the entity on the other end of a communications link) is supported in various scenarios, all of which rely on Public Key technology and electronic certificates (well-known to the industry). Authentication scenarios supported by WOLF adapters include: Adapter Authenticating Adapter, Adapter Authenticating LDAP (in encrypted path scenarios, using SSL (Secure Socket Layer), LDAP Authenticating Adapter (dependent on implementation and configuration of Directory Service implementation), Adapter Authenticating dbLog Manager/Logging Database, Adapter Authenticating JMX Console, Adapter Authenticating RMI Command Line, Adapter Authenticating SNMP Console.

Integrity (validation that a message has not been tampered with between sending and arrival) is supported between WOLF adapters by the automatic, internal electronic signing of messages (using Public Key technology and electronic certificates).

Data may also be protected against viewing by unauthorized parties by use of data encryption (using SSL—Secure Socket Layer). SSL communication links may be used in the following communication paths: Adapter to Adapter, Adapter to LDAP, Adapter to dbLog Manager/Logging Database, Adapter to JMX Console, Adapter to RMI Command Line, Adapter to SNMP Console.

Error Logging

WOLF Adapters provide access to classes that can be used for error logging. Developers can preferably access these classes to log messages for their applications. Messages sent to the logging system exposed through WOLF classes can be controlled as to the depth of output, based on message severity.

As depicted in FIG. 1, WOLF adapters transfer data between Service Providers 50 (such as a domain's legacy systems) and Requesters 60 (Clients). Both Clients 60 and Service Providers 50 require WOLF adapters. FIG. 1 shows one implementation of a pair of WOLF adapters exposing data from one Service Provider to one Client. However, multiple adapters can be implemented for any single Service Provider and/or any single Requester thereby effecting a “many-to-many” architecture.

As shown, the adapter is preferably structured in a tiered manner. Lower tiers are simplified and represent the common case capability, leaving capabilities that are more complex in the upper tiers. Further, WOLF adapters can preferably take advantage of information in a variety of existing naming and directory services—such as DNS, NDS, NIS (YP), and X.500, and especially LDAP servers. This flexibility is not only useful in linking to service providers in a variety of environments; it also helps deter any implementation-specific artifacts in the WOLF adapter.

The diversity of service providers and naming services in the organization (enterprise) can be supported with seamless integration. This integration allows new Java application and service programmers to export their own services in a uniform way. For example, a “thin-client” may be better served by a proxy-style protocol in which the access to a domain service is relegated to a server. In other situations, a resource-rich client may choose an implementation that allows it to directly access the various servers. The application is insulated from these implementation choices. These choices (e.g., servers, number of service providers and location) may be deferred until deployment.

A WOLF adapter is preferably used when it is planned to externalize an interface (make known the data and semantics of a legacy system). A WOLF adapter is preferably written for a Service Provider:

when it is planned to provide for client access (either same-domain or cross-domain) to a legacy system;

when it is desired to manage access (funnel) a portion of legacy data to other users; when multiple domains require access;

when an efficient index of legacy semantics and data is required,

when an existing defined interface might be re-used or when no well defined interface exists.

Requesters, on the other hand, use WOLF adapters to find information (data and semantics) on legacy systems. WOLF adapters also hide complexities of remote communication to Service Providers.

The WOLF adapter is preferably implemented using industry-standard tools and protocols to provide maximum flexibility in connecting service providers. These standards preferably include:

- Java Naming and Directory Interface (JNDI);
- Directory Service Markup Language (DSML);
- Extensible Modeling Interchange (XMI);
- Hypertext Transport Protocol (HTTP);
- Java Management Extensions (JMX);
- Java Remote Method Invocation (RMI);
- Lightweight Directory Access Protocol (LDAP);
- Java API for XML Processing (JAXP);
- Java Messaging Service (JMS);
- Secure Hypertext Transport Protocol (HTTPS); and
- Simple Network Management Protocol (SNMP).

Models, Service Providers and Requesters

In terms of the current invention, a model is a description of an interface, the services on the interface and the data used by those services that are to be exposed by a Service Provider. Models for WOLF Service Providers are preferably described using the Unified Modeling Language (UML). Models simplify the display of complex processes to a number of audiences. The UML document created when building WOLF adapters becomes the reference in the relevant domain for business analysts, developers, and the adapter itself (once exported in XMI format) at run time.

Models can be created using any UML-compliant tool that can export data in Extensible Metadata Interchange (XMI) format.

An interface is a collection of services that can be made available to Requesters via WOLF adapters. Thus, in accordance with the present invention, interfaces are described in models and are bound by one or more adapters in order to invoke specific services. Likewise, one adapter instance may support multiple interfaces.

Connecting Service Providers and Requesters

Requesters and Service Providers exchange information via WOLF adapters. More specifically, Requesters invoke services made available by Service Providers. These services are exposed through WOLF interfaces to requesting application(s). Both Requesters and Service Providers use WOLF Adapters for the exchange of this information.

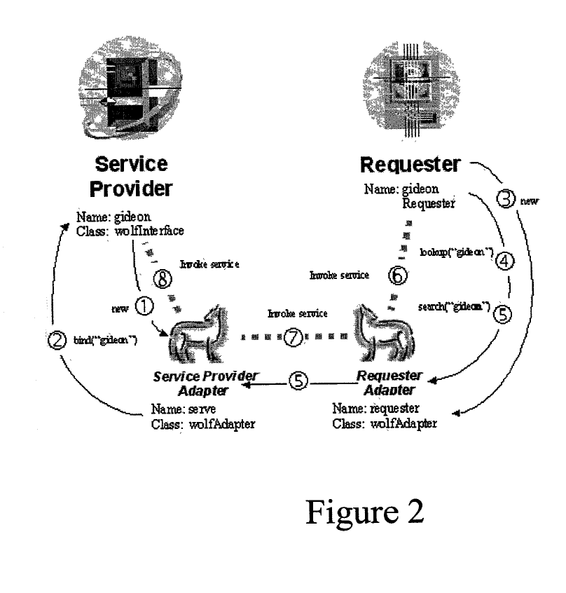

As explained below and with reference to FIG. 2, Service Providers make an interface available by “binding” one or more interfaces to a WOLF adapter. Requesters use a WOLF Adapter to “lookup” an interface and subsequently invoke specific services.

FIG. 2 depicts actions taken between Service Providers and Requesters via WOLF adapters to exchange information over an enterprise network. At step 1 the Service Provider (in this case named “gideon”) identifies an adapter that is active and connected. At step 2 the Service Provider adapter (in this case named “serve”) binds to the Service Provider. At step 3 the Requester (in this case named “gideon Requester”) identifies an adapter (named “requester”) that is active and connected. Then, at step 4 gideon Requester asks requester to resolve an address and “find” gideon via serve (step 5). At step 6 gideon Requester invokes service from gideon via requester. At step 7 Requester invokes service from serve and at step 8 serve invokes service from gideon.

WOLF Models

WOLF adapters for systems in a domain are preferably based on object modeling tools, development tools and sample code. The following describes how one can develop a model for an adapter, export that model to XMI, generate Java code from the XMI and implement the model as a Service Provider Adapter.

Reviewing an Existing UML Model

A model is a description of an interface, the services on the interface and the data used by those services that are to be exposed by a WOLF adapter. As previously explained, models for WOLF adapters are preferably described using the Unified Modeling Language (UML) and rendered using Extensible Metadata Interchange (XMI). The following describes the management of an existing UML Model. Creating a new UML Model is described later herein.

The overall process for reviewing a model using a UML tool comprises:

1. Use an existing UML model of the system to be used by WOLF.

2. Identify data and services to be exposed using the WOLF adapter.

3. Review the components of the logical diagram.

4. Save the preexisting model with a new name to retain the original model while making modifications to the copy.

Those skilled in the art will appreciate how to manipulate or modify a UML model to create a model having the desired functionality.

Building a New UML Model

To develop a new model, one should be familiar with the existing system from which services are to be exposed and the specific services that are to be exposed from the particular domain. Thus, the overall process for building a new model comprises:

1. Gathering existing documentation on the domain.

2. Identifying data and services to be exposed using the WOLF adapter.

3. Analyzing services into logical groups (this will be the interface).

4. Analyzing data into logical units. (These will become the data classes identified by the services above).

5. Creating a UML model.

6. Publishing the UML model.

When an entirely new model is created, it should preferably be reviewed and approved by a ‘domain expert’ before publication. Since this model is how the outside world “sees” the domain, it is important that it is complete in its definition, yet is flexible enough to be modified and improved at a later date without having to start again from scratch.

Exporting a Model to Java

In the preferred embodiment of the present invention, the model created from a preexisting model or one that is created from scratch is ultimately published for use by the adapter at runtime, and exported to Java and made available in a file that is used by Requesters. Techniques for accomplishing the export function are well known in the art and include, for example,

1. Locating the UML model to be exported;

2. Exporting the UML model to XMI.

3. Generating Java code that from XMI.

4. Confirming that the Java file output from the XMI accurately reflects the original model.

5. Compiling the Java code.

In accordance with the present invention a tool is preferably provided to facilitate the implementation of a UML model. Functionality provided by the tool, much of it implemented as feature plug-ins, includes the following: (1) It creates java interfaces and Data Beans from XMI. (2) It compiles the generated java. (3) It archives the compiled java. (4) It creates runtime version information that is separate from java version information. (5) It publishes a domain interface. (6) It puts configuration information in the Directory. (7) It packages and deploys generated artifacts in a java jar file (8) It deploys XMI. (9) It checks for versioning information. (10) It constructs Convenience functionality (i.e. strategies, test harness, exception handling, problem notification, database, data schema from copybooks or data structures). (11) It generates Skeleton classes (i.e. “boilerplate” code for implementing generated interfaces—these include Convenience functionality, etc.). (12) It validates the data contract in the model. (13) It facilitates reuse by suggesting similar existing classes that exist. (14) It generates non-Java implementation (i.e. language bindings). (15) It does Web service creation. (16) It generates documentation (i.e., javadoc, UDDI, WSDL, an audit trail of chosen deployment, installation instructions).

The present invention preferably also includes a Configuration tool to facilitate the configuration of adapters. Functionality provided by the tool includes the following: (1) It checks the validity of structure and data specific to the implementation of the invention. (2) It provides assistance for configuration of adapters (i.e. default values for fields, prioritization of configuration information, etc.). (3) It automates migration between different development/production environments. (4) It helps navigate connections between domains and service providers, etc.

Implementing an Exported Model as a Service Provider

The overall process for implementing an exported model's interface as a Service Provider adapter comprises:

1. Implementing the Java interface created.

2. Testing the interface.

Configuring WOLF Service Providers

Service Providers are preferably configured such that they connect to their information providing applications access security information and establish a protocol for communication with other WOLF adapters. This configuration preferably takes place using the Configuration Tool and comprises modifying entries in a WOLF Directory Schema. The WOLF Directory Schema, in accordance with the present invention, describes the types of objects that a directory may have and the mandatory and optional attributes of each object type. Characteristics of the WOLF adapter are preferably represented as entries in the directory and its information as attributes of those entries. Subentries in the directory preferably contain the schema definitions for object classes and attribute type definitions used by entries in a specific part of the directory tree. The process for configuring Service Providers assumes that a service(s) has been modeled in UML, exported to XMI, implemented in Java and tested. The following steps are preferably carried out, using the Configuration Tool, to configure the Service Provider for usage with WOLF adapters:

1. Copy configuration defaults from an existing configuration.

2. Paste the JNDI nodes into the appropriate location for a domain in an LDAP compliant directory on a Directory server.

3. Customize values for the Service Provider adapter

a. Configure attributes for Security and Authentication

b. Configure attributes for Management and Message Logging

c. Configure attributes for Transports (for all protocols of Interfaces hosted on the adapter)

4. Customize values for the Depot

a. Include the location of the XMI generated from the model

5. Customize values for the Interface

a. Include thename of the Interface(s) modeled in UML

b. Include the name of the protocol (HTTP, HTTPS, RMI, etc.) supported by the Interface(s)

Configuring WOLF Requesters

Requesters are preferably configured such that they also recognize their information-providing applications, access security information and establish a protocol for communication with other WOLF adapters. This configuration preferably takes place using the Configuration Tool and comprises modifying entries in a WOLF Directory Schema.

The following steps are carried out to configure Requesters for usage with WOLF adapters:

1. Copy configuration defaults from an existing configuration.

2. Paste the configuration entries into the new directory in the domain.

3. Rename the JNDI nodes in the LDAP compliant directory to appropriate names for the domain

4. Customize values for the Requester adapter

a. Configure attributes for Security and Authentication

b. Configure attributes for Management and Message Logging

c. Configure attributes for Transports (for all protocols supported by Interfaces which will be called by the Requester)

A Requester Adapter object is an instantiation of a Client API to services exposed through the WOLF Adapter. Its instance is created and its reference held by the Client (java) application that calls the Provider service(s). The Client java application, rather than the WOLF Requester class, has a Java main method. The Requester object runs in the same instance of the Java Virtual Machine as its Client Application, and continues as long as it is held by the Client application.

WOLF Requester objects are called as local java objects. The services which the Requester object exposes are java methods on local “proxy” objects, which delegate to the remote services. The requesting application does not have to address the complexities of remote communication or have specific knowledge of the Service Provider. Standard java calls are made to the published API of the services.

Additional Famework

There are three main parameters that are preferably fed to this framework through Environment variables (i.e. java System properties):

adapter.name—The fully qualified JNDI name of the Requester adapter instance.

domainInterface.name—The fully qualified JNDI name of the interface that the provider supports. This is the interface being called.

adapter.provider.url—The URL of the JNDI implementation that holds the configuration information. This may be an LDAP server, an eDirectory server, or a DSML (Directory Service Markup Language) file.

Additional parameters that may also be fed to the framework through java System Properties include:

adapter.security.authentication—Type of authentication to be used for access to the JNDI context.

adapter.security.principal—JNDI parameter representing a user name for access to the JNDI context.

adapter.security.credentials—The password for the security principal.

WOLF Adapter Exceptions

The primary source of problems in WOLF adapter development are usually the result of configuration errors. These errors, along with other difficulties encountered by WOLF adapter software, result in exceptions (error messages) that are sent to a developer's (programmer's) command line.

The following summarizes the exceptions and exception handling, as well some typical exceptions that are handled by the present invention. From time to time, as in all software applications, errors may occur within the WOLF adapter environment. These errors (called exceptions) are sent from Requester and/or Service Provider adapters. An exception is an event that occurs during the execution of a program that disrupts the normal flow of instructions. In the Java programming language, errors from either the runtime Java environment or the Java application are wrapped as Java exception objects, which can then be passed back to calling programs. These objects contain information about the event, including program state when the error occurred and calling stack trace information. The runtime system must then find code to handle the error. Creating an exception object and passing it to the system is called “throwing an exception.”

Preferably, in the WOLF environment, as with all exceptions in Java, a message log can be reviewed to see which class and method the exception was received in. This helps give an indication as to what was being attempted when the exception was thrown.

The exceptions in the WOLF Adapter are “chained” so that they appear in the message log along with lower-level exceptions embedded within. This, effectively, gives a stack trace of what occurred leading-up to the exceptions.

Common Adapter Layer Exceptions

Most Adapter exceptions trace back to problems in configuration. The Adapter Exception found in the message log preferably contains a specific message for the exception condition along with any embedded exceptions.

Common Depot Layer Exceptions

Most Depot layer exceptions also trace back to problems in configuration. The Depot Exception found in the message log preferably contains a specific message for the exception condition along with any embedded exceptions. Depot errors are returned as NameNotFoundException. The message text preferably provides some detail.

Common Fabricator Layer Exceptions

The Fabricator layer of the WOLF Adapter generates a number of exceptions to describe problems with the marshalling and unmarshalling processes during processing of a request for information between Requesters and Service Providers.

The following are typical Client exceptions.

Client Marshal Exception—This exception is generated when errors occur while marshalling or encoding a request into a SOAP payload.

Client Unmarshal Exception—This exception is generated when errors occur while unmarshalling from or decoding a response, which was sent back after a service invocation, into a SOAP payload.

Remote Exception—A Remote Exception is generated by the Requester to indicate any exception thrown by the Service Provider Adapter. Each exception generated by the Fabricator causes a SOAP Fault Envelope to be passed from the Service Provider to the Requester. The Requester Adapter throws the Remote Exception when it receives the SOAP Fault Envelope.

The following are typical Server (Service Provider) exceptions:

Server Unmarshal Exception—This exception is generated when errors occur while decoding a SOAP payload on the Service Provider side.

Unbound Exception—This exception is thrown when no Service Provider implementation has been bound to the WOLF Adapter to the Requester interface.

Server Marshal Exception—This exception is thrown when errors occur while marshalling or encoding the Response at the Service Provider into a SOAP payload to be sent back to the client.

Service Not Found Exception—If the Service Provider does not provide the service requested then a Service Not Found Exception is generated.

Service Invocation Exception—A Service Invocation Exception is generated when the Service Provider throws any exception. This exception indicates a problem with the implementation of service that will require the attention of Service Provider Developers.

Common Management Layer Exceptions

Most Management layer exceptions experienced when first starting an adapter trace back to problems in configuration. The Management Exception found in the message log preferably contains a specific message for the exception condition along with any embedded exceptions, such as the ones described below.

Remote Exception—Thrown when there are problems with RMI components. A common cause for this exception is when a class that must be transmitted over the network does not implement java.io.Serializable, or an rmiregistry is not running on either the local or target computer.

Naming Exception—Thrown by parts of the system that access JNDI, and indicates that the requested name does not exist or has an invalid format.

Manageable value exceptions listed below are preferably thrown by the JMX management interface components and indicate problems finding manageable values.

Attribute Not Found Exception

Mbean Exception

Reflection Exception

Invalid Attribute ValueException

Runtime Operations Exception

Invalid Argument Exception

Adapter Layer Id Exception—Thrown when AdapterLayerId.getInstance( ) is called with the same value for the identifier more than once.

Adapter Init Exception—Thrown when a miscellaneous problem occurs during initialization of an adapter. This exception is chained, so one can see the real exception that caused the problem in the first stack trace.

Common Transport Layer Exceptions

Most Transport exceptions experienced when first starting an adapter trace back to problems in configuration. The Transport Exception found in the message log will contain a specific message for the exception condition along with any embedded exceptions.

Runtime exceptions—Information required for debugging Transport exceptions experienced at runtime (i.e. after some messages have been successfully passed) can be gathered from the message within Transport Exception and any embedded exceptions. This information can be found in the message log.

Remote exceptions—Remote exceptions can be thrown via Remote Method Invocation (RMI) to management consoles that are not hosting WOLF Adapters. The following are remote exceptions thrown via the Transport layer.

HTTP and HTTPS—The embedded HTTP Server within a WOLF adapter configured as a Service Provider communicates status (success or failure of a message) back to the Requesting adapter through standard HTTP Return Codes. For example, a Return Code of “200” means that the message request was successful.

Service Provider Adapter—Exceptions caught while a WOLF Service Provider adapter (i.e. server) is trying to process an HTTP request are reflected in the message within the TransportException thrown on that server. This exception is written to the message log. Because an exception was thrown, the HTTP server generates a Return Code indicating the error. A message explaining the error is also preferably included.

Requester Adapter—On the Requesting adapter (i.e. Client), the HTTP Return Code (and accompanying message) causes a Transport Exception to be thrown on that Client adapter. The message received from the HTTP server is contained in the Transport Exception message. The Transport Exception is written to the message log.

RMI—Exceptions caught on the Service Provider Adapter (i.e. server) while trying to process a message request are contained in a Transport Exception generated on the Service Provider adapter and written to the message log. Exceptions related to the actual remote processing of RMI are contained in a Remote Exception, which will be caught on the Requesting Adapter (i.e. client). These exceptions may be embedded inside a Transport Exception on the client.

Example of Actual Implementation

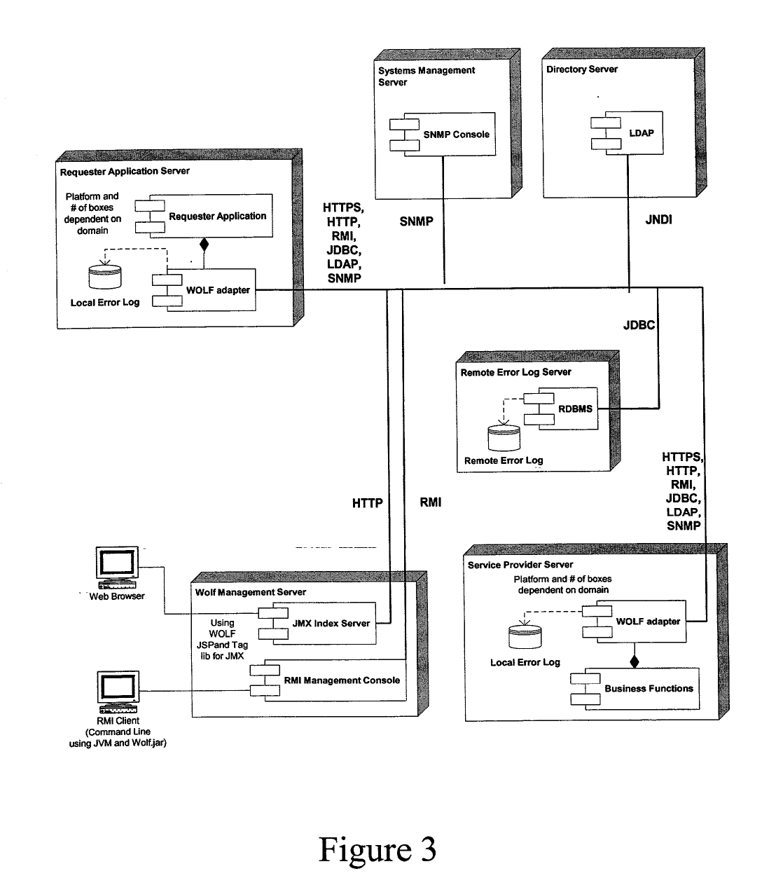

FIG. 3 shows an exemplary logical implementation of the present invention. The Figure includes the generalized data flow and component relationships of a functioning WOLF production environment. Each of the elements shown in FIG. 3 is described below.

Service Provider Server—The Service Provider Server (platform and number of actual computers dependent upon the domain) makes one or more services available to other applications, domains or other applications within a domain. The following components will typically be found on the Service Provider Server:

Business Functions. Business Functions are accessed through WOLF Services (such as returning a list of retail customers) from mainframe applications within or across domains to Requesters. These services are logically bundled and exposed through Java interfaces, which Requesters call via WOLF adapters.

WOLF Adapter. Provides a simple, standardized way to pass requests for information from Requesters to the Service Provider and to return the results. WOLF Provider Adapters run in their own machine process, listening for requests.

Local Error Log. Storage area for messages (such as error logging) generated by the WOLF Service Provider Adapter.

Requester Application Server—This server contains the business logic for two-way data transmissions to and from Service Providers. The platform and number of actual computers are dependent upon the domain. This Requester makes requests for data from applications both within and outside the requesting domain via WOLF Adapters and includes the following components:

Requester Application. Application that queries one or more services within one or more Service Provider domain interfaces.

WOLF Adapter. Provides a simple, standardized way to pass requests for information from Requesters to the Service Provider and to return the results. WOLF Requester Adapters run in the same machine process as the Requester Application.

Local Error Log. Storage area for messages (such as error logging) generated by the WOLF Requester Adapter.

Systems Management Server—WOLF adapters can communicate with centralized console management interfaces via Simple Network Management Protocol (SNMP). SNMP traps are preferably sent to Systems Management Servers throughout the organization to provide critical status information, such as alerts about service-affecting conditions within the adapter. Additional monitoring systems may be deployed as desired.

WOLF Management Server—Management of WOLF Adapters can be done through each Adapter instance. Or, as in the case of this diagram, management functions can be centralized on a WOLF Management Server. The following components typically exist on this server:

JMX Index Server—Sun Corporation's Java Management Extensions (JMX) is an on-demand tool for adapter management. In order to manage the adapter, Administrators access the JMX Index Server using a Web Browser, such as Netscape Navigator Version 4.5 or later or Microsoft Internet Explorer Version 4.0 or later. The Index Server provides URL links directly to WOLF Adapter instances for management of those instances.

RMI Management Console—Administrators may alternatively use a Java enabled Client to manage WOLF Adapters using a Command Line. The RMI Client needs to have access to RMI Proxies which are available in a java “jar” file.

Directory Server—The Directory server is used to store configuration information for WOLF adapters. The server is accessed by WOLF Adapters at runtime. The directory (typically, LDAP) is used also as a Naming Service (a concept well-know to those in the industry). At runtime, WOLF Service Providers also “bind” services to the directory. WOLF Requesters use the directory at runtime to “lookup” services, hence, providing location transparency of Service Providers. The WOLF adapters preferably have their own directory namespace, which is integrated into the organization-wide namespace. Directory servers are accessed by WOLF Adapters using JNDI, which provides abstraction by which multiple directory implementations may be accessed through the same interface.

Process of Deploying a New WOLF Adapter

An advantage of the present invention is its ability to be quickly deployed, which helps speed the time-to-market of web-based financial or other types of products. In addition to supplying a universal solution for connecting legacy systems to the web, for example, the process of implementing a WOLF adapter is infinitely repeatable.

The following steps are preferably implemented to fully deploy an adapter in accordance with the present invention.

1. Initiate a project with domain management.

2. Identify the application owners, key developers, implementers and support personnel.

3. Locate and/or situate the Service Provider machine.

4. Locate and/or situate the Requester machine.

5. Select a transport protocol.

6. Install and configure software on the appropriate machines.

7. Enter the appropriate WOLF Adapter data in the LDAP database.

8. Setup database logging.

9. Determine support roles.

10. Prepare for migration to production environment.

11. Migrate to production environment.

Each of the aforementioned steps is elaborated upon in the description below.

1. Typically, a domain management office must be contacted to initiate a project involving the development of a WOLF adapter in accordance with the present invention.

2. To ensure that models are prepared in an accurate way, the application owners, key developers, implementers and support personnel for the domain should be identified. These individuals may include:

Senior Manager

Application Owner

Lead Architect, if any

Lead Application Developer

Technical Support staff (second-level support)

Information collected is useful in understanding the system architecture, identifying where the adapter will reside, and determining connections between legacy systems and application clients.

3. Locating and/or situating the Service Provider machine comprises determining what existing machine may host the adapter or whether it may be more desirable to install a new machine to serve as the Service Provider. This step is preferably completed in consultation with the domain architects and design engineers, who can advise on hardware, operating system and network requirements. Generally, the Service Provider machine functions as a gateway to a backend legacy application. In the case of a new Service Provider, space needs to be reserved for servers and/or connections need to be defined for mainframe applications.

4. Locating and/or situating the Requester machine (if necessary) comprises determining what existing machine may host the client-side adapter or whether it may be desirable to install a new machine to serve as the Requester. This step is also preferably completed in consultation with the domain architects and design engineers, who can advise on hardware, operating system and network requirements. The Requester machine receives data via the WOLF adapter and passes it to a client application (for example, a web server for display on a web page). The requesting adapter instance resides in the same machine process as the client application. In the case of a new Requester, potential space needs to for servers and network connections need to be defined.

5. Selecting a transport protocol. Depending upon the application, the transport protocol could be HTTP, HTTPS, MQ or some other transport protocol. This step is preferably completed in consultation with the domain architects and network engineers, who will recommend a protocol based on the application's requirements.

6. Installing and configuring software on the appropriate Service Provider and/or Requester machine comprises a certain amount of customization by the Application Developers for setup of interfaces and adapters. In view of the foregoing, Application Developers should be granted access to the Service Provider and Requester machines in the development and production environments.

7. Entering the appropriate WOLF Adapter data in the appropriate directory services (LDAP) database might require consultation with network Database Architecture and Administration Groups.

8. Setting up logging for the WOLF Adapter preferably comprises configuring a centralized destination system (indicated as “SNMP Console” in FIG. 3) to receive SNMP traps forwarded by the adapter and creating and configuring an Oracle database to receive and store adapter log information.

9. Preparing to place the WOLF adapter in the production environment preferably comprises complete appropriate documentation that defines any new Service Provider or Requester hardware and software and supply the environment's Operations Manager with a diagram that contains specific adapter connectivity information. Additionally, this step also includes defining roles for staff required to support the WOLF adapter and supply a Help Desk and/or Problem Management System with application support contact information.

10. In large enterprises it is important to contact a Production Acceptance (PA) office (or similar authority) to obtain quality assurance certification for placing the adapter in the production environment. Among other tasks, the PA office can perform load testing, failover/recovery tests, security validation and calling tree verification.

11. Finally, a Change Management office (or similar authority) should be contacted for information on completing a business and technical (B&T) review of the application and for scheduling the migration of the adapter to the production environment. Again, large enterprises, for which the present invention is particularly useful, often have rigorous supervisory systems and procedures in place in an effort to avoid computer system failure, which can effect, in possibly very significant ways, the operation of the enterprise.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for facilitating data communication between a first computer system operable as a service provider and a second computer system operable as a requester, comprising:
an electronic network;
a service provider adapter comprising a first set of software layers interposed between the first computer and the electronic network; and
a requester adapter comprising a second set of software layers interposed between the second computer and the electronic network,
wherein the service provider adapter publishes a model of services that are available from the first computer and the requester adapter accesses the model and employs the model as an interface to the first computer via the service provider adapter.

2. The system of claim 1, wherein the first computer comprises at least one of an application and a database to be exposed to another at least one of an application and a database on the second computer.

3. The system of claim 2, wherein the second computer is logically within the same business domain as is the first computer.

4. The system of claim 2, wherein the second computer is outside of a business domain in which the first computer is logically located.

5. The system of claim 1, wherein the first and second sets of software layers are the same but are inversely ordered.

6. The system of claim 1, wherein the first set of software layers comprises at least two of an adapter layer, a depot layer, a fabricator layer and a transport layer.

7. The system of claim 1, wherein the second set of software layers comprises at least two of an adapter layer, a depot layer, a fabricator layer and a transport layer.

8. The system of claim 1, wherein the model of services is published to a naming and directory interface.

9. The system of claim 8, wherein the naming and directory interface is implemented in java.

10. The system of claim 1, wherein the service provider adapter is in communication with at least one of a convenience module and a management module.

11. The system of claim 1, wherein the requester adapter is in communication with at least one of a convenience module and a management module.

12. The system of claim 1, wherein a common protocol is used between the service provider adapter and the requester adapter across the electronic network.

13. The system of claim 1, wherein the service provider adapter is operable to bind to at least one interface.

14. The system of claim 1, wherein the model of services comprises a description of an interface.

15. The system of claim 1, wherein the requester adapter is operable to search for an interface.

16. The system of claim 1, wherein the first and second computers are controlled by the same organization.

17. The system of claim 16, wherein the organization is a bank.

18. The system of claim 1, wherein the first computer comprises a legacy system.

19. The system of claim 1, further comprising a plurality of service provider adapters connected to the first computer and a plurality of requester adapters connected to the second computer.

20. The system of claim 1, wherein the first and second set of software layers comprise a fabricator layer that is plugable.

21. The system of claim 20, wherein the fabricator layer is a library.

22. The system of claim 1, wherein the first and second set of software layers comprise a transport layer that is plugable.

23. The system of claim 22, wherein the transport layer is a library.

24. The system of claim 1, wherein the first and second set of software layers comprise a management layer that is plugable.

25. The system of claim 24, wherein the management layer is a library.

26. A system for facilitating data communication between a first computer system operable as a service provider and a second computer system operable as a requester, comprising:
an electronic network;
a service provider adapter interposed between the first computer and the electronic network; and
a requester adapter interposed between the second computer and the electronic network,
wherein the service provider adapter publishes a model of services that are available from the first computer and the requester adapter accesses the model and employs the model as an interface to the first computer via the service provider adapter.

27. The system of claim 26, wherein the first computer comprises at least one of an application and a database to be exposed to another at least one of an application and a database on the second computer.

28. The system of claim 26, wherein the second computer is logically within the same business domain as is the first computer.

29. The system of claim 26, wherein the second computer is outside of a business domain in which the first computer is logically located.

30. The system of claim 26, wherein the service provider adapter and requester adapter are each comprised of a plurality of software layers.

31. The system of claim 30, wherein the software layers comprise at least two of an adapter layer, a depot layer, a fabricator layer and a transport layer.

32. The system of claim 26, wherein the model of services is published to a naming and directory interface.

33. The system of claim 32, wherein the naming and directory interface is implemented in java.

34. The system of claim 26, wherein the service provider adapter is in communication with at least one of a convenience module and a management module.

35. The system of claim 26, wherein the requester adapter is in communication with at least one of a convenience module and a management module.

36. The system of claim 26, wherein a common protocol is used between the service provider adapter and the requester adapter across the electronic network.

37. The system of claim 26, wherein the model of services comprises a description of an interface.

38. The system of claim 26, wherein the requester adapter is operable to search for an interface.

39. The system of claim 26, wherein the first and second computers are controlled by the same organization.

40. The system of claim 39, wherein the organization is a bank.

41. The system of claim 26, wherein the first computer comprises a legacy system.

42. The system of claim 26, further comprising a plurality of service provider adapters connected to the first computer and a plurality of requester adapters connected to the second computer.

43. In an organization operating a legacy computer application having a non-standard data retrieval interface, a system for extracting data from the legacy computer application, comprising:
a first computer running the legacy computer application;
a service provider adapter connected to an input/output of the first computer;
a second computer;
a requester adapter connected to an input/output of the second computer; and
a directory services server in communication with both the service provider adapter and the requester adapter,
wherein the directory services server stores a listing of modeled interfaces representing services available from the legacy computer application, the modeled interfaces having been published to the directory services server, and wherein the requester adapter accesses at least one of the interfaces listed by the directory services server and thereby gains access to the legacy computer application.

44. The system of claim 43, wherein the service provider adapter and the requester adapter comprise substantially the same software elements.

45. The system of claim 43, wherein the service provider adapter and the requester adapter comprise at least one of an adapter layer, a depot layer, a fabricator layer and a transport layer.

46. The system of claim 45, wherein at least one of the fabricator and transport layer is plugable.

47. The system of claim 43, wherein the service provider adapter and the requester adapter are in communication with at least one of a management module and a convenience module.

48. The system of claim 43, wherein the service provider adapter and the requester adapter communicate with each other using a common format.

49. The system of claim 43, wherein the first and second computers are within the same organization.

50. The system of claim 43, wherein the directory services server is searchable.

51. In an organization operating a legacy computer application having a non-standard data retrieval interface, a method of retrieving data in a standardized fashion, the method comprising the steps of:
identifying a Service Provider computer on which the legacy computer application is loaded;
identifying a Requester computer;
selecting a network encoding scheme;
selecting a transport protocol;
installing and configuring adapter software on the Service Provider and Requester computers, the adapter software being operable to communicate via the transport protocol;
publishing an interface model to a central location; and
causing the Requester computer to access the central location to gain access to the Service Provider computer and retrieve data by employing the interface model.

52. The method of claim 51, wherein the interface is published to a directory and naming server.

53. The method of claim 51, further comprising searching for an interface model.

54. The method of claim 51, wherein the Service Provider computer and the Requester computer are within a same domain.

55. The method of claim 51, wherein the transport protocol is at least one of HTTP, HTTPS and MQ.

56. The method of claim 51, wherein the step of causing the Requester computer to access the central location to gain access to the Service Provider computer comprises encoding data.

57. The method of claim 36, wherein encoding comprises utilizing SOAP.
